(19) United States
(12) Patent Application Publication
(10) Pub. No.: US 2026/0329707 A1
(43) Pub. Date: Oct. 22, 2026

(54) SEQUENCING SERVICE FENCING WITH MEMBERSHIP EVENT DELIVERY IN A DISTRIBUTED SYSTEM

(71) Applicant: Dell Products L.P., Round Rock, TX (US)

(72) Inventors: Shefali Gautam, San Mateo, CA (US); George Mathew, Belmont, CA (US); Niharika Avasarala, Pleasanton, CA (US)

(21) Appl. No.: 19/186,500

(22) Filed: Apr. 22, 2025

(51) Int. Cl. G06F 11/20; G06F 9/455

(52) U.S. Cl. CPC G06F 11/2023; G06F 9/45558; G06F 11/2046; G06F 2009/45562; G06F 2009/45587; G06F 2009/45595

(57) ABSTRACT

Membership changes in distributed systems in cluster systems are sequenced to prevent any data corruption from by down nodes being able to continue to access shared resources. A sequenced service fencing component receives an indication from a membership service detecting a node as live or down. The component performs input/output (I/O) fencing to fence on and off nodes from accessible shared services before it publishes the node down and node up event. The node down or node up event is published only after the fencing operation is successfully completed.

### TECHNICAL FIELD

Embodiments are directed to distributed file system networks, and specifically to sequencing service fencing with membership event delivery to prevent data corruption.

### BACKGROUND

A distributed (or cluster) file system is a type of file system in which data is spread across multiple storage devices provided in a cluster of nodes. Each computer forms a node in the system and runs its own instance of an operating system. The file system is shared by being simultaneously mounted on multiple servers, and presents a global namespace to the nodes so that files appear to be in the same central location. Distributed file systems are typically very large and may contain many hundreds of thousands or even many millions of files, as well as services (applications) that use and produce data. The Santorini file system provided by Dell Technologies, Inc. represents a type of cluster network system that stores the file system metadata in a distributed key value store (KVS) and the file data on object store. The metadata can be accessed by any front-end node, and any file can be opened for read/write by any front-end node.

In a distributed system involving a cluster of nodes, every node has access to a set of critical shared services like a database, the file system, a key-value store, message queues, and so on. These shared services are essential in storing and managing data and metadata and most nodes have the ability to read and write to one or multiple such services. The access to these shared services is sometimes done using tokens that are assigned to a node (by a controller node) for a certain time interval and upon expiration of that interval, must be refreshed.

Most distributed systems implement a membership management layer that monitors whether a node is alive (e.g., based on heartbeats or gossip) and if a node is detected as down due to lack of heartbeats or any other reason, the node down event information is published to other live nodes. Typically, this is implemented by delivering ordered membership events to a reliable and persistent message queue, and then to all the live (or active) members. Upon receipt of an event, every live node that has subscribed to a membership change event processes the event by executing a pre-determined function. Each subscriber could take different failover actions, such as to reallocate resources of the failed node to a surviving node. This failover action is generally not coordinated with the components of the shared services so there is a strong possibility that while the node down event is queued, delivered, and executed, the failed node could still be running and maintaining its continuous access to the shared services, which can lead to data corruption. For example, in the event of a network partition, it is possible that while a node down event is queued and delivered, the inaccessible node could still be reading from and writing to a shared service and potentially corrupting the data.

What is needed, therefore, is a membership service that detects a node as live or down, and fences off nodes from accessible shared services before it publishes the node up/down events.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions. Dell, Data Domain, and Santorini are trademarks of Dell Technologies, Inc.

### BRIEF DESCRIPTION OF THE DRAWINGS

In the following drawings like reference numerals designate like structural elements. Although the figures depict various examples, the one or more embodiments and implementations described herein are not limited to the examples depicted in the figures.

FIG. 1 is a block diagram of illustrating a distributed system implementing sequenced service fencing with membership event deliver for cluster networks, under some embodiments.

FIG. 2 illustrates a high-level overview of a network cluster using the Santorini architecture, under some embodiments.

FIG. 3A illustrates details of the services related to the data path running in Santorini cluster network, under some embodiments.

FIG. 3B illustrates a Santorini scale-out file system consisting of stateless independent Data Domain services that are responsible for the data path, under some embodiments.

FIG. 4 illustrates the operation of a cluster event-notification module, under some embodiments.

FIG. 5 illustrates an example case of fencing off services at the time of event generation.

FIG. 6 illustrates a membership of cluster event-notification manager (CEM) registered services, under some embodiments.

FIG. 7 illustrates an example implementation of a CEM in a Kubernetes cluster system (e.g., Santorini), under some embodiments.

FIG. 8 illustrates an example cluster network implementing a CEM and KVS controller in a DDFS system, under some embodiments.

FIG. 9 is a flowchart that illustrates a method of performing I/O fencing in conjunction with membership functions in a cluster system, under some embodiments.

FIG. 10 illustrates an example of a system applying a fencing process in conjunction with membership, under some embodiments.

FIG. 11 is a block diagram of a computer system used to execute one or more software components for the distributed system of FIG. 1, under some embodiments.

### DETAILED DESCRIPTION

A detailed description of one or more embodiments is provided below along with accompanying figures that illustrate the principles of the described embodiments. While aspects of the invention are described in conjunction with such embodiments, it should be understood that it is not limited to any one embodiment. On the contrary, the scope is limited only by the claims and the invention encompasses numerous alternatives, modifications, and equivalents. For the purpose of example, numerous specific details are set forth in the following description in order to provide a thorough understanding of the described embodiments, which may be practiced according to the claims without some or all of these specific details. For the purpose of clarity, technical material that is known in the technical fields related to the embodiments has not been described in detail so that the described embodiments are not unnecessarily obscured.

It should be appreciated that the described embodiments can be implemented in numerous ways, including as a process, an apparatus, a system, a device, a method, or a computer-readable medium. Applications, software programs or computer-readable instructions may be referred to as components or modules. Applications may be hardwired or hard coded in hardware or take the form of software executing on a general-purpose computer or be hardwired or hard coded in hardware such that when the software is loaded into and/or executed by the computer, the computer becomes an apparatus for practicing the invention. In this specification, these implementations, or any other form that the invention may take, may be referred to as techniques. In general, the order of the steps of disclosed processes may be altered within the scope of the described embodiments.

Embodiments are directed to a data logging system and method that provides a single consistency point for cluster file systems to facilitate snapshot-based recovery in a deduplication backup system.

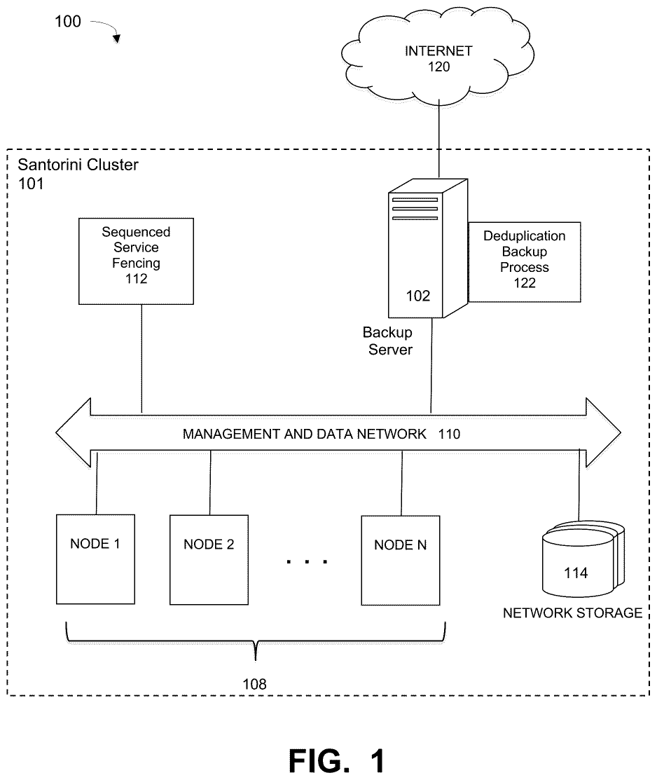

FIG. 1 is a block diagram illustrating a distributed system implementing sequenced service fencing with membership event delivery for cluster networks, under some embodiments. System 100 comprises a large-scale network that includes a cluster network 101 having a number of different devices, such as server or client computers 102, nodes 108, storage devices 114, and other similar devices or computing resources. Other networks may be included in system 100 including local area network (LAN) or cloud networks, and virtual machine (VM) storage or VM clusters. These devices and network resources may be connected to a central network, such as a data and management network 110 that itself may contain a number of different computing resources (e.g., computers, interface devices, and so on). FIG. 1 is intended to be an example of a representative system implementing a distributed computing system under some embodiments, and many other topographies and combinations of network elements are also possible.

A distributed system 101 (also referred to as a cluster system, cluster file system, or cluster network) typically consists of various processing components that run in different computer systems (nodes) that are connected to each other. These components communicate with each other over the network via messages and based on the message content, perform certain acts like reading data from the disk into memory, writing data stored in memory to the disk, perform some computation (CPU), sending another network message to the same or a different set of components and so on. These acts or ‘component actions,’ when executed in time order in a distributed system constitute a distributed operation.

A distributed system may comprise any practical number of compute nodes 108. For system 100, n nodes 108 denoted Node 1 to Node N are coupled to each other and a connection manager 102 through network 110. The connection manager can control automatic failover for high-availability clusters, monitor client connections and direct requests to appropriate servers, act as a proxy, prioritize connections, and other similar tasks.

In an embodiment, cluster network 101 may be implemented as a Santorini cluster that supports applications such as a data backup management application that coordinates or manages the backup of data from one or more data sources, such as other servers/clients to storage devices, such as network storage 114 and/or virtual storage devices, or other data centers. The data generated or sourced by system 100 may be stored in any number of persistent storage locations and devices, such as local client or server storage. The storage devices represent protection storage devices that serve to protect the system data through applications 104, such as a backup process that facilitates the backup of this data to the storage devices of the network, such as network storage 114, which may at least be partially implemented through storage device arrays, such as RAID (redundant array of independent disks) components. The data backup system may comprise a Data Domain system, in which case network 101 supports various related file system and data managers, such as PowerProtect Data Manager (PPDM), as well as services such as ObjectScale object storage and other services.

In an embodiment, network 100 may be implemented to provide support for various storage architectures such as storage area network (SAN), Network-attached Storage (NAS), or Direct-attached Storage (DAS) that make use of large-scale network accessible storage devices 114, such as large capacity disk (optical or magnetic) arrays for use by a backup server, such as a server that may be running Networker or Avamar data protection software backing up to Data Domain protection storage, such as provided by Dell Technologies, Inc.

Although embodiments are described in the context of Data Domain file system (DDFS) and a Santorini cluster system, embodiments are not so limited and any architecture that requires a distributed logging service within given, configurable resources may be used.

Cluster network 101 includes a network 110 and also provides connectivity to other systems and components, such Internet 120 connectivity. The networks may be implemented using protocols such as Transmission Control Protocol (TCP) and/or Internet Protocol (IP), well known in the relevant arts. In a cloud computing environment, the applications, servers and data are maintained and provided through a centralized cloud computing platform.

In an embodiment, cluster network 101 implements containerization technology through a Kubernetes implementation. A container is a virtualized computing environment to run an application program as a service or microservice, and are lightweight, portable data constructs that are decoupled from the underlying infrastructure. Applications are run by containers as microservices with the container orchestration service facilitating scaling and failover. For example, the container orchestration service can restart containers that fail, replace containers, kill containers that fail to respond to health checks, and will withhold advertising them to clients until they are ready to serve.

In an embodiment, system 100 uses Kubernetes as an orchestration framework for clustering the nodes 1 to N in FIG. 1. Application containerization is an operating system level virtualization method for deploying and running distributed applications without launching an entire VM for each application. Instead, multiple isolated systems are run on a single control host and access a single kernel. The application containers hold the components such as files, environment variables and libraries necessary to run the desired software to place less strain on the overall resources available. Containerization technology involves encapsulating an application in a container with its own operating environment, and the well-established Docker program deploys containers as portable, self-sufficient structures that can run on everything from physical computers to VMs, bare-metal servers, cloud clusters, and so on. The Kubernetes system manages containerized applications in a clustered environment to help manage related, distributed components across varied infrastructures. Certain applications, such as multi-sharded databases running in a Kubernetes cluster, spread data over many volumes that are accessed by multiple cluster nodes in parallel.

In Kubernetes, a pod is the smallest deployable data unit that can be created and managed. A pod is a group of one or more containers, with shared storage and resource requirements. Pods are generally ephemeral entities, and when created, are scheduled to run on a node in the cluster. The pod remains on that node until the pod finishes execution.

In an embodiment, the support bundle process 112 is used in a clustered network that implements Kubernetes clusters. One such example network is the Santorini system or architecture, though other similar systems are also possible.

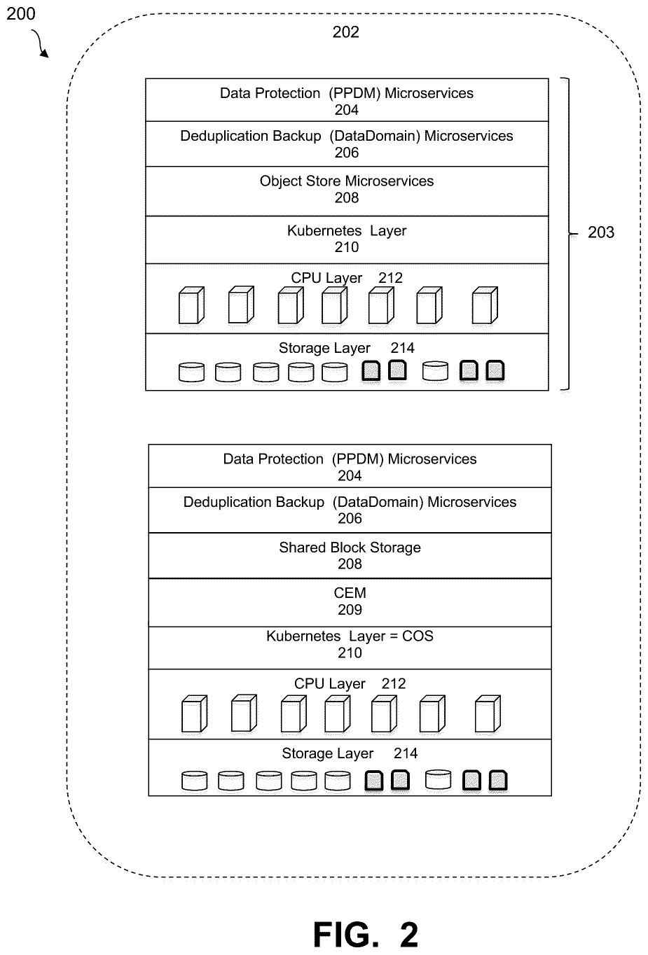

FIG. 2 illustrates a high-level overview of a network cluster using the Santorini architecture, under some embodiments. In system 200 of FIG. 2, a two-node cluster 202 is shown. Each node 203 consists of several distinct components or processing layers. For the example shown, a node includes a PowerProtect Data Manager (PPDM), or similar microservices layer 203, a Data Domain (deduplication backup) appliance microservices layer 206, a shared block storage layer 208, a Kubernetes layer 210, a processor layer 212, and a storage layer 214 including different types of storage media, such as HDD, Flash memory, SSD memory, and so on. Each of these component products consists of multiple microservices, and as more nodes are added, Santorini scales CPU, storage, RAM, and networking accordingly. Other layers can also be included, and a cluster 202 may comprise any practical number of nodes 203. The PPDM represents a cloud-native data protection manager system, and ObjectScale represents a scalable object storage manager.

As shown in FIG. 2, embodiments of the cluster network 200 through DD microservices 206 utilize Data Domain backup appliances to provide streaming deduplication, and which use the Data Domain File System (DDFS) as an inline data deduplication file system. As data gets written to the file system, DDFS creates variable sized segments and writes the unique segments to a compression region. A number of compression regions are grouped together and written as a container to disk. DDFS calculates fingerprint signatures for each segment using SHA1 algorithm. DDFS has an on-disk fingerprint index table, which maps the fingerprint to the container-ID, that has the corresponding segment data. The container has a metadata section followed by several data sections. The data sections store the compression regions; and the container metadata section stores the meta information of the container, i.e., it stores the total number of compression regions, the total number of segments, the fingerprint of each segment, and so on.

In a deduplicated file system that forms segments from data, these segments are uniquely identified by their key/label called a ‘fingerprint.’ Given a file offset and length, the corresponding data segment fingerprints need to be looked up. To provide faster offset to fingerprint lookup the mapping is stored in a Merkle tree format where the leaf nodes represent data segments and their fingerprints are stored in the parent nodes which are metadata segments. In a Merkle tree, every non-leaf node is labeled with the hash of the labels of its children nodes to allow efficient and secure verification of the contents of large data structures.

With respect to the directory tree structure of the data processed in system 100, various different data structures can be supported by the file system (e.g., DDFS or Santorini file system). A B+Tree is self-balancing tree structure and is a variant of a standard B Tree, and Each file inode is stored in the B+Tree as a data blob using the parent directory inode number and the child file inode number as the key. A B+Tree key structure composed of the parent directory inode as the primary key and child file inode as the secondary key to construct the full key. An M tree is a tree data structure similar to a B+Tree (or R-tree), which is constructed using a metric and relies on triangle inequality for efficient range and k-nearest neighbor queries. As with other tree-based data structures, the M tree is composed of nodes and leaves. In each node there is a data object that identifies it uniquely and a pointer to a sub-tree where its children reside. Every leaf has several data objects

A file in DDFS is represented by a Merkle tree with user data as variable sized segments at the bottom level of the tree, referred to as L0 segments. The SHA1 fingerprints of those segments are grouped together at the next higher level of the tree to form new segments, referred to as L1 segments. SHA1 fingerprints of L1 segments are grouped together as L2 segments, and this continues up to L6 which represents the entire file. The top segment of the tree is always an L6 segment, even though it may refer to any lower numbered segments. Segments above L0 are referred to as Lp chunks. The L6 segment of every file is stored in a namespace which is represented as a B+Tree. The L0 and Lp segments are written to separate containers, known as L0 and Lp containers.

A Data Domain or similar system can efficiently copy an existing file using the same underlying Merkle tree. It creates the new file with a new name, and therefore a new L6 root of the tree, but that tree then references the identical L_{P} chunks. As this operation involves only the root of the tree, it is trivially fast and does not increase physical space in use beyond the one chunk containing the L₆.

In an embodiment, the PPDM (PowerProtect Data Manager) microservices layer 204 builds on the Data Domain system 206 to provide data protection capabilities for VM image backups and Kubernetes workloads.

Upon creation of an M tree, it can identify the domain on which the M tree is created. All namespace metadata as well as the file data and metadata associated with a M tree is allocated from resources owned by that domain. The M tree names as well as M tree IDs are unique across the cluster. Santorini exposes a global namespace that is a union of all namespaces in all domains.

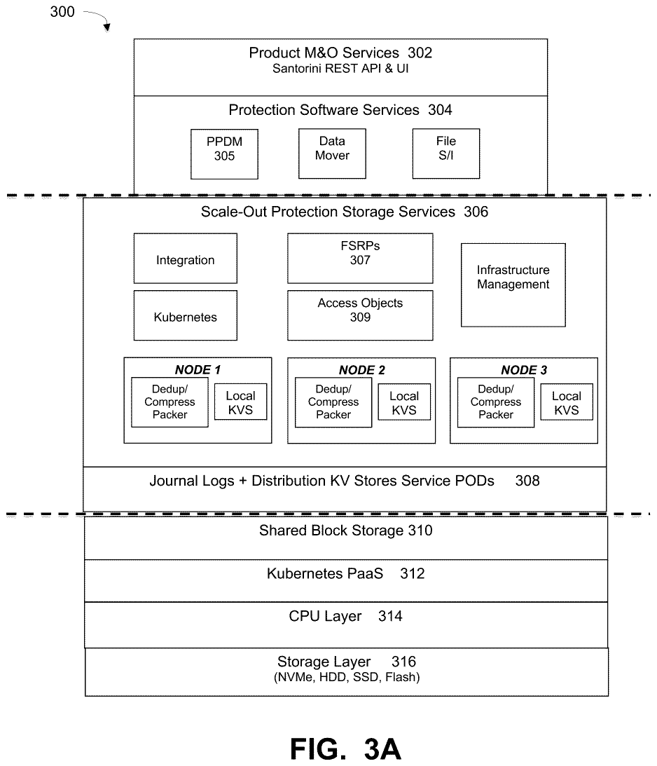

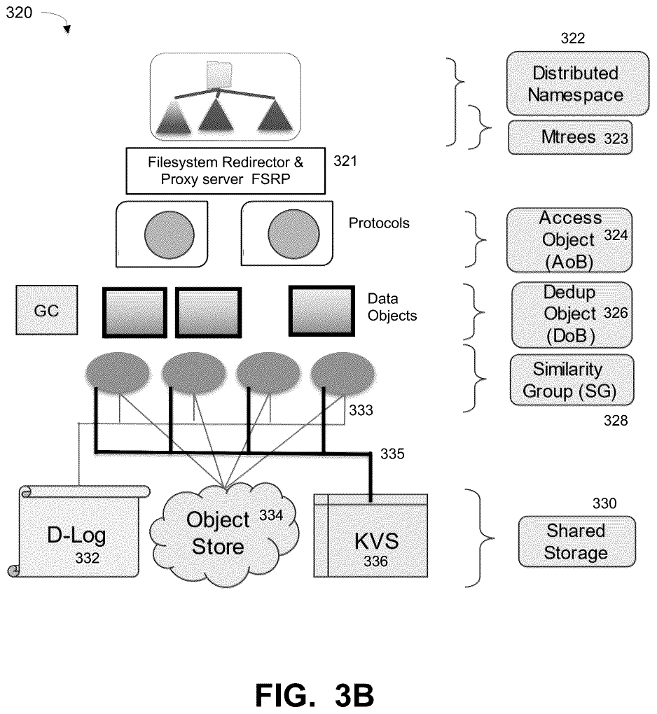

FIG. 3A illustrates details of the services related to the data path running in Santorini cluster network, under some embodiments. As shown in diagram 300, a product services layer 302 provides the necessary REST APIs and user interface utilities. The API server implements a RESTful interface, allowing many different tools and libraries can readily communicate with it. A client called kubecfg is packaged along with the server-side tools and can be used from a local computer to interact with the Kubernetes cluster.

Below layer 302, the protection software services layer 304 includes a data manager (e.g., Power Protect Data Manager, PPDM) component 305 that provides backup software functionality. Within the scale-out protection storage services layer 306, the File System Redirection Proxy (FSRP) service 307 redirects file operations in a consistent manner based on the hash of a file handle, path, or other properties to instance of the access object service 309. The access object service 309 handles protocols and a content store manager. This means that files are segmented and the Lp tree is constructed by an access object 309. The FSRP 307 redirects file system accesses in a consistent way to the access objects 309 so that any in-memory state can be reused if a file is accessed repeatedly in a short time, and it avoids taking global locks. Also included in layer 306 are any number of nodes (e.g., Nodes 1 to 3, as shown), each containing a dedup/compression packer and a key-value (KV) store.

As an L1 is formed, a similarity group (simgroup) is calculated for the L1 based on the SHA1 fingerprints of the L0 segments (or other properties). The similarity group is checked against a mapping table, which leads to consistently routing the L1 based on its similarity group to an instance of a node's dedup/compress service. If similarity groups are in a range of 0-1023, then if there are four instances of the dedup/compress service, then the instances may uniquely be responsible for the ranges 0-255, 256-511, 512-767, 768-1023, though other mappings are possible. The dedup/compress instance will deduplicate the L0 segments relative to other fingerprints within the same similarity group. Other functionality exists in the dedup/compress service such as packing segments into compression regions, containers, and blobs that will be written to an underlying object storage such as provided by the shared block storage 310, or an object store provided by the public cloud. Other layers of system 300 include a Kubernetes PaaS (platform as software) 312, a CPU layer 314, and a storage layer 316.

Distributed key value stores in 308 are also a component of Santorini and are used to hold much of the metadata such as the namespace Btree, the Lp tree, fingerprint index, and container fingerprints. These run as containers within the Santorini cluster and are stored to low latency media such as NVMe 316. There is also a distributed and durable log that replaces NVRAM for Santorini.

In summary, Santorini is an integrated scale out software solution developed by Dell Technologies that can run on-premises or in a public cloud. In an embodiment, the Santorini stack consists of PPDM as backup software, Data Domain scale out file system, and Object Scale as a storage pool, and these are run as services inside the Kubernetes container infrastructure.

FIG. 3B illustrates a Santorini scale-out file system consisting of stateless independent Data Domain services that are responsible for the data path. The file system 320 comprises a distributed namespace 322 organized into a directory tree structure, such as M trees 323. The DDFS functionality is split between an Access Object (AoB) service 324, a Deduplication Object (DoB) service 326, a garbage collection service (GC), and a File System Redirector and Proxy (FSRP) 321. The distributed namespace 322 is spread across all of the access objects 324. The data set is divided into a number (e.g., thousands) of small collection partitions comprising the similarity groups (SG) 328. The file data and metadata is stored in shared storage 330 interfaced through data access lines 333 and metadata access lines 335. The data is stored in an object store 334, while the metadata is stored in a distributed Key Value Store 336. System 320 facilitates data replication from and to existing Data Domain Restorers, and similar components. The file system services can be scaled up or down as appropriate and a distributed log (D-Log) 332 stores the data of the similarity groups.

### Service-Fencing With Membership Event Delivery

As stated above, in present distributed systems, failures of nodes create failover actions that are not necessarily coordination among the components of the shared services. This creates the possibility that while the node down event is queued and executed, the failed node could still be continually accessing the shared services, leading to possible data corruption.

As shown in FIG. 1, embodiments of system 100 include a sequenced service fencing component (or programmed process) 112 that is configured to receive an indication from a membership service detecting a node as live or down, and then fence on and off nodes from accessible shared services before it publishes the node down and node up event. Both these actions are performed atomically meaning that the node down or node up event is published only after the fencing operation is successfully completed.

The fencing operation to block and allow access to the shared service can be implemented in a variety of ways, such as by deactivating and reactivating the access tokens that belong to the failed node, or other similar means.

This atomic execution of the fencing operation to allow shared service access along with the node down event publishing, ensures that the shared services are not accessible to the nodes that have failed before any failover action is taken, thereby ensuring data reliability. In the event of a network partition, the inaccessible node will error out while trying to access the shared service. Similarly, before a node up event is queued, the system makes sure that fencing on operation has been successfully processed.

In a distributed system, fencing of input/output (I/O) operations is achieved by utilizing the membership information maintained by the cluster membership orchestration service. The membership list of active members is used to determine which service incarnations should be given access. Based on the storage layer, membership information is used to grant and revoke access to that specific storage layer.

For block storage, this can be achieved by creating a unique reservation key for persistent storage reservation for each block storage access service that comes into membership at the time the service is initializing. When a service instance goes down and the membership orchestrator detects this change in membership, it will revoke the unique reservation key for that service and invalidates access for that service to block storage. The order of events can also be orchestrated by the cluster membership manager to ensure that resources are reassigned only after access is revoked for the service that is down or partitioned. This can protect against inconsistencies and maintain data integrity. If the service then comes back up and joins membership again, it can be granted new reservation keys for accessing block storage.

Similarly, the same membership information can be utilized by other storage layers like a distributed data store (key-value store or KVS) to discern which service is in membership and can be granted access to write to the KVS. When a service is being initialized, the membership orchestrator will provide the service instance information to be used for fencing to the KVS service, which uses this membership information to update its internal access list of valid clients. When a service is down or partitioned out due to node partition, the membership orchestrator ensures the KVS gets the membership change and access list is updated before the service down is processed by the rest of cluster. This ensures resources are migrated to available services efficiently only after all access control to those resources is processed and those resources are fenced off from invalid older service instances.

In a Santorini (or similar) system, membership changes can occur at any time, such as for services being added as part of scaling or crash due to failures, or existing services getting restarted. Such membership changes need to be processed by existing services to execute error recovery workflow or re-distribute data across other existing services in a certain predefined order.

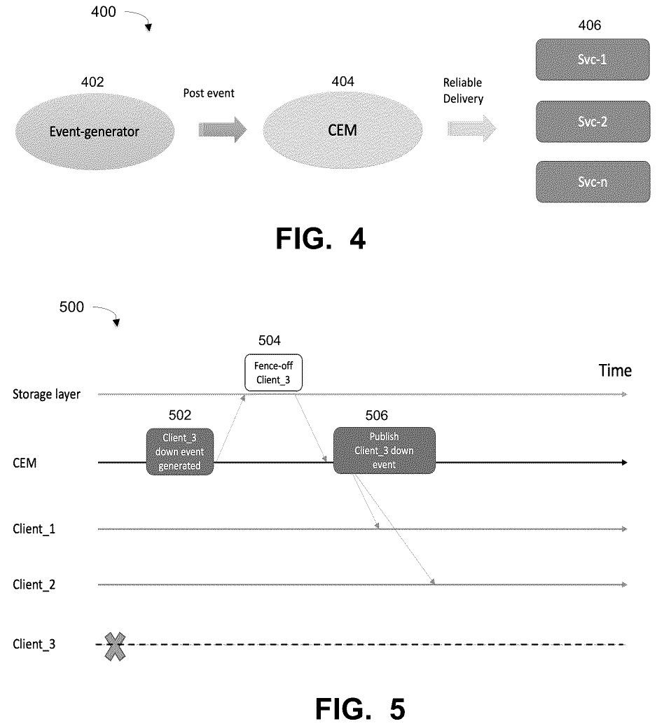

In an embodiment, the distributed system includes a cluster event-notification module (CEM), such as CEM 209 shown in FIG. 2 that can be implemented as a customizable and portable lightweight module using a smart client library. The CEM 209 provides reliable event delivery with exactly once semantics. FIG. 4 illustrates the operation of a cluster event-notification module, under some embodiments. As shown in diagram 400 of FIG. 4, one or more event generators 402 events that impact cluster membership to the CEM 404. The CEM, in turn, delivers these events to the relevant services 406. The event generators 402 can be any component or service, and the services can likewise be any appropriate component or service as well.

The CEM 402 can be used by any service that requires membership events to be delivered to in the order of occurrence or any service that needs to receive the same sequence of events as other CEM members. It can also be used by any service that needs to know the current membership or process events in a hierarchical order, or any service that needs to post custom event such that it is delivered in the order of occurrence.

In an embodiment, the CEM can also be used by any service that needs to be fenced-off in storage-layer using CEM membership. FIG. 5 illustrates an example case of fencing off services at the time of event generation. Diagram 500 of FIG. 5 shows the interaction of the storage layer, CEM, and clients during the occurrence of a crash of a particular client, i.e., Client_3. In this case, The CEM generates a Client_3 down event message 502. This is delivered to the storage layer, which issues a command 504 to fence off Client_3. The CEM then publishes 506 this command to the remaining connected clients Client_1 and Client_2. This fencing operation prevents Client_3 from being able to continue to access shared resources while being processed as failed.

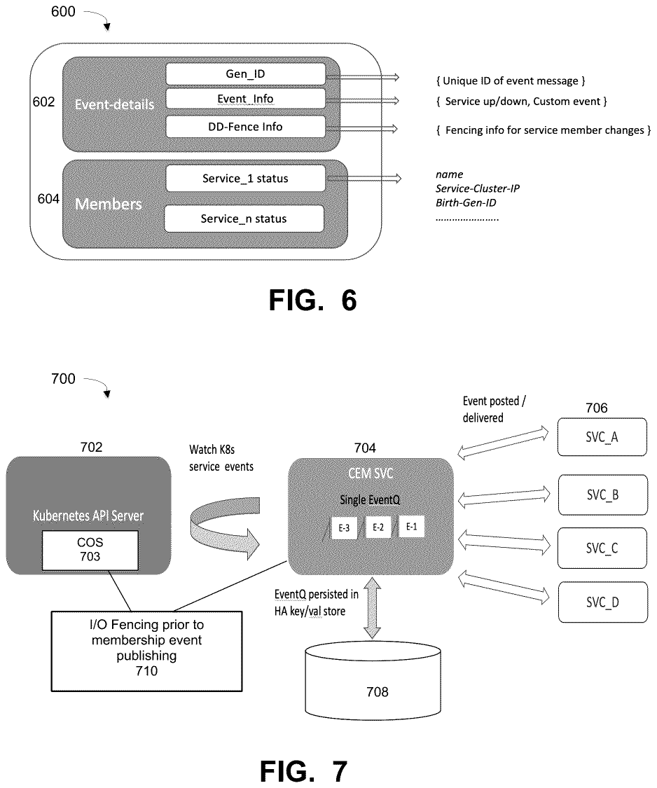

In a Santorini system, services register to or with the CEM, which then maintains a member list of existing services, and each member information includes a birth/join generation number. FIG. 6 illustrates a membership of CEM registered services, under some embodiments. As shown in FIG. 6, the membership data element 600 includes an event-details section 602 and a status of the registered members 604. The event-details include a unique ID of an event message (Gen_ID), event-info, such as service up/down, and so on, and fencing information for service member changes (DD-Fence-Info). The membership status 604 includes name, cluster information and birth/join information for each service (e.g., Service_1 to Service_n). FIG. 6 is provided as an example, and any other format or composition of a CEM-maintained membership of registered services can be used.

In a Santorini system, such as shown in FIG. 3B, FSRPs 321 use the CEM to obtain the AoB 324 membership information, and the AoBs use the CEM to learn the membership status and start log replays for dead AoBs, if necessary. The CEM is also used to implement I/O fencing for AoBs 324, the KVS 336 and the distributed log, 332.

Membership changes in distributed systems, particularly in Kubernetes clusters can occur due to service crashes, partial availability, network partition scenarios, and so on. Sequencing membership changes and fencing off services before publishing events is needed to prevent data corruption. In an embodiment, the I/O fencing is performed before membership changes are published. In general, there are only two meaningful membership events: service down and service up The membership service itself ensures that only entities in the current membership can access shared resources. The CEM monitors services through Kubernetes and fences off services before queuing events. In addition, resource allocation and load balancing is done by registered services. The CEM approach of FIG. 4 makes fencing a part of the membership change itself. Fencing is thus integrated with membership in their system, and can be implemented in a variety of ways, such as by a distributed log, shared land, and key-value store.

FIG. 7 illustrates an example implementation of a CEM in a Kubernetes cluster system (e.g., Santorini), under some embodiments. As shown in system 700, a Kubernetes API server 702 generates service events that are monitored by the CEM component or service 704. The CEM 704 maintains a single queue for all events. and watches and queues the service events with respect to its members, who are subscribed services 706 (e.g., SVC_A, SVC_B, SVC_C, and SVC_D). The CEM queues events posted by the members and delivers event information as appropriate. The event delivery is decoupled from the queuing. The event queue is persisted in a high availability KVS, such as storage 708. The client services 706 register with the CEM 704 and both listen to events and post events.

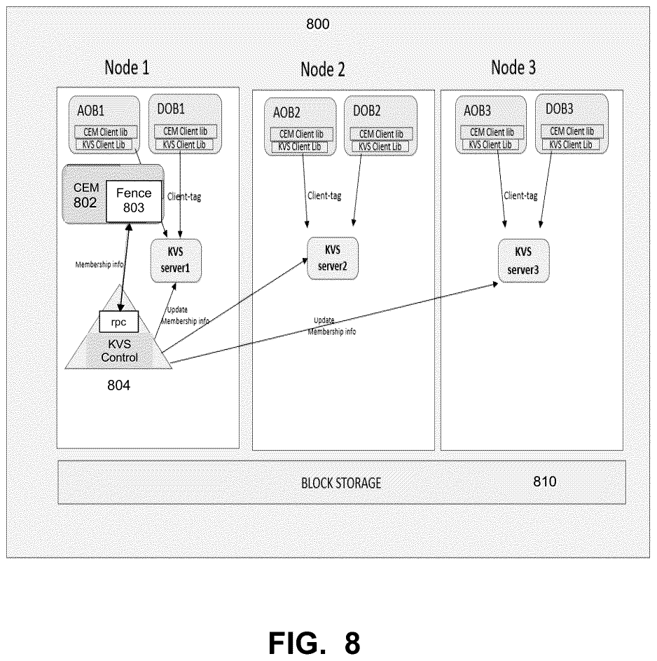

In an embodiment, the CEM in one node of a cluster along with a KVS controller that updates membership information for each of the nodes. FIG. 8 illustrates an example cluster network implementing a CEM and KVS controller in a DDFS system, under some embodiments. System 800 shows three example nodes (Node1, Node2, and Node3) each having respective AoB and DoB components, and block storage 810. The AoBs and DoBs each comprise respective CEM client libraries and a KVS client libraries. Thus Node1 has AoB1 with a CEM Client lib and KVS Client Lib, and DoB1 with its own CEM Client lib and KVS Client Lib, and likewise for Node2 and Node3, as shown. Each node also has its own KVS server (e.g., KVS server1, KVS server2, KVS server3).

One node, in this case Node1 has a CEM 802 that communicates with the AoB of the node (here, AoB1) through a remote procedure call (RPC) or similar mechanism. The fencing process 803 has a DD Fence library and its own RPC mechanism to communicate with the KVS controller 804. In each node, the KVS client libraries in each of the respective AoBs and DoBs provide a client-tag to the KVS server for the corresponding node. The fencing process 803 in the CEM 802 provides membership information to the KVS controller 804, and the controller then updates the membership information in the KVS server in each node.

For a cluster event involving subscribing a new node, the CEM and DD-Fence component create a unique block access service (BAS) key for the new node and registers the key for write access reservation. The new node then uses its unique BAS key to acquire reservation and perform I/O operations on the block storage 810, and the other nodes likewise use their already registered keys to perform their I/O operations. For a cluster event involving a node going down, the CM E unregisters the unique BAS key for that node. The down node cannot then acquire any reservations using its existing key for write operations, though the other nodes can still use their keys and continue I/O operations.

With reference back to FIG. 7, in an embodiment, system 700 includes a mechanism to deliver and process cluster membership events in a cluster of nodes that implement and run a container orchestration service (COS) to prevent data corruption by sequencing membership changes and fencing off services before publishing events, and that also facilitates the CEM in monitoring services and managing resource allocation. In an embodiment, the COS 703 is implemented as Kubernetes process or entity that itself runs a pod, container, or process. The CEM basically runs a pod/container in a Kubernetes system so it interacts with the Kubernetes API server to watch certain resources, such as pods (health).

In an embodiment system 700 includes a processing component 710 that performs the I/O fencing process before publishing membership events. At a high level, the component detects a node status as up or down, fences on and off nodes from accessible shared services before it publishes the node down and node up event so that a node up event is only published after the fencing is successfully completed. In this way, the fencing operation is essentially integrated with the membership function of nodes and resources in the cluster system.

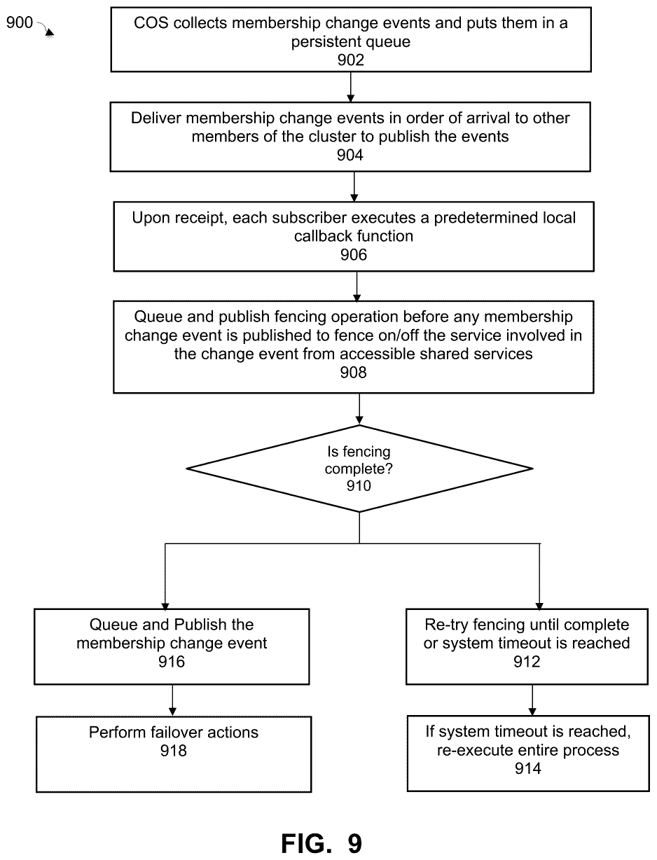

FIG. 9 is a flowchart that illustrates a method of performing I/O fencing in conjunction with membership functions in a cluster system, under some embodiments. As shown in FIG. 9, process 900 begins with membership change events (i.e., node off/on) being collected from the container orchestration service (COS) and queued to a reliable and persistent queue, 902.

The membership change events are processed in an orderly manner by delivering them in order of their arrival in the queue to all other members of the cluster system, 904. This constitutes the publishing of the events.

Upon receipt of such an event, each subscriber executes a local callback function, which is predetermined for that particular event, 906. One example of a callback function is network-management service performing service-failover after receiving a service-down message. For example, consider three data-path services AoB1/2/3 owning files called f1/f2/f3. When any AoB goes down, the AoB-controller service will do the recovery for the down AoB and move the resources to other available AoBs so that file access can still be accomplished. This is executed as part of the callback. When a client registers with CEM, they provide a callback and state its priority_id that defines the order of callback execution across all the members. For example, if an AoB down event needs to be processed by svc_1 and svc_2; but svc_2 has defined a higher priority for the callback, the event will first be processed by svc_2 and then svc_1, and this is all managed by the CEM.

An additional fencing operation before any membership change event is queued and published; this fencing operation will fence on and off the service involved in the change event from the accessible shared services. The fencing is done within the CEM itself, so when a service down event is caught by the CEM, it will first fence off the down service from shared storage and then queue it. The CEM does not queue the event without fencing the corresponding service, so the fencing essentially executes from inside the CEM and is sequenced with the queuing operation.

As shown in FIG. 9, the process 900 waits until the fencing operation is successfully completed, as determined in step 910. Upon its successful completion, the membership change event is then queued and published to the other nodes, 916. After this, any appropriate failover action can be performed, 918. This could include allowing active nodes to take over the shared resources of the down node, attempting to resurrect the down node, and so on.

Both the actions of fencing and membership change event queuing/publishing are performed atomically which means that the service down or node up event is published in step 910 only after the fencing operation in step 908 is successfully completed.

If the fencing operation could not be completed as determined in step 910, the process retries the fencing a defined number of times until the fencing operation is completed or the entire operation reaches a pre-defined timeout, 912. If the timeout period is crossed, the entire process can be re-executed after a predetermined interval, 914. The defined number of times in step 912 and the system timeout period in step 914 can be set to any appropriate respective values, such as five times and 15 minutes, or any other similar values.

The fencing process as implemented in cluster-membership is not limited to containerized aware modules. This means fencing can still be implemented even if the shared storage (e.g., block storage 810) resides outside Kubernetes or any other container orchestration system.

Although embodiments are described in relation to failed and fenced off services, it should be noted that any appropriate cluster system component may be considered a service, such as a node, process, resource, component, and so on. Thus, the term “service” and “node” may be used interchangeably herein.

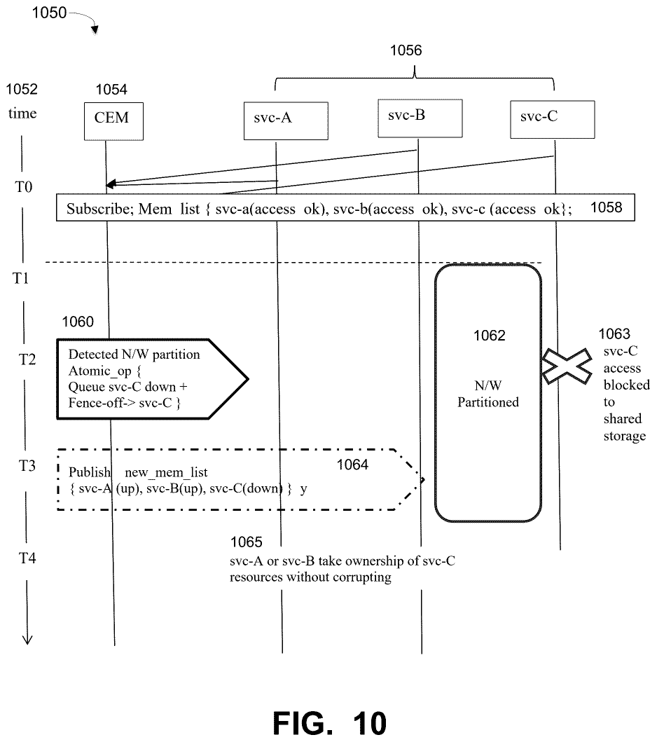

FIG. 10 illustrates an example of a system applying a fencing process in conjunction with membership, under some embodiments. System 1050 of FIG. 10 comprises a CEM 1054 and three example services 1056 denoted svc-A, svc-B, and svc-C. Certain membership events occur along a timeline 1052 at certain intervals, such as denoted T0, T1, T2, T3, T4, and so on.

In FIG. 10, a first membership event occurs at T0 and comprises a subscription to a membership list where all of the services 1056 are allowed access to the shared resources (access ok). At a later time (e.g., T2), the system detects a partition event (or crash or other occurrence) that results in svc-C effectively going down. This results in the CEM 154 queuing and publishing an I/O fencing operation 1060 to fence off svc-C. This is shown as a network (N/W) partitioned state 1062 for svc-C, which indicates the time that the node was out of the network. For the example shown, after T1, svc-c was partitioned out, but it took some time for CEM to detect the svc-c to be down after the network partition, i.e., around T2. The fencing off blocks access by svc-C to the shared storage, 1063.

After the fencing operation is successfully completed, the system publishes a new member list showing svc-A and svc-B up and svc-C down, 1064. Svc-C has its access blocked, so any other service can take over ownership of svc-C resources without corrupting any data, 1065.

Embodiments of process 900 thus process membership changes in cluster systems in a way that minimizes chances of data corruption by fencing off failed nodes before publishing the event information to ensure that the failed nodes are blocked from shared services before the failover actions begin.

### System Implementation

Embodiments of the processes and techniques described above can be implemented on any appropriate backup system operating environment or file system, or network server system. Such embodiments may include other or alternative data structures or definitions as needed or appropriate. The processes described herein may be implemented as computer programs executed in a computer or networked processing device and may be written in any appropriate language using any appropriate software routines. For purposes of illustration, certain programming examples are provided herein, but are not intended to limit any possible embodiments of their respective processes.

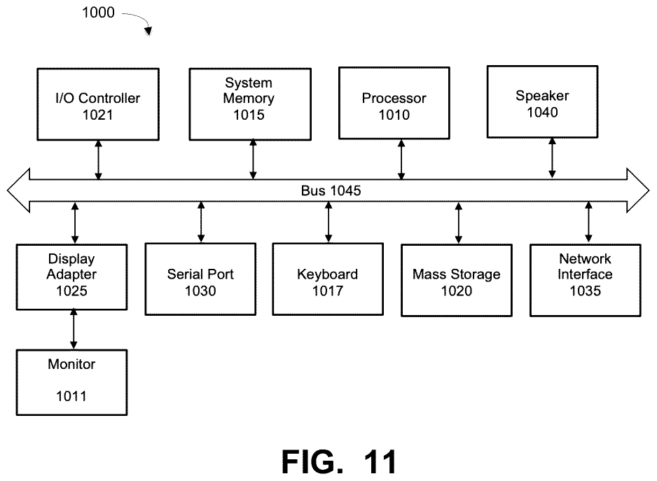

The network of FIG. 1 may comprise any number of individual client-server networks coupled over the Internet or similar large-scale network or portion thereof. Each node in the network(s) comprises a computing device capable of executing software code to perform the processing steps described herein. FIG. 11 is a block diagram of a computer system used to execute one or more software components of a logging and audit log generation processing component, under some embodiments. The computer system 1000 includes a monitor 1011, keyboard 1017, and mass storage devices 1020. Computer system 1000 further includes subsystems such as central processor 1010, system memory 1015, input/output (I/O) controller 1021, display adapter 1025, serial or universal serial bus (USB) port 1030, network interface 1035, and speaker 1040. The system may also be used with computer systems with additional or fewer subsystems. For example, a computer system could include more than one processor 1010 (i.e., a multiprocessor system) or a system may include a cache memory.

Arrows such as 1045 represent the system bus architecture of computer system 1000. However, these arrows are illustrative of any interconnection scheme serving to link the subsystems. For example, speaker 1040 could be connected to the other subsystems through a port or have an internal direct connection to central processor 1010. The processor may include multiple processors or a multicore processor, which may permit parallel processing of information. Computer system 1000 is an example of a computer system suitable for use with the present system. Other configurations of subsystems suitable for use with the present invention will be readily apparent to one of ordinary skill in the art.

Computer software products may be written in any of various suitable programming languages. The computer software product may be an independent application with data input and data display modules. Alternatively, the computer software products may be classes that may be instantiated as distributed objects. The computer software products may also be component software. An operating system for the system may be one of the Microsoft Windows®. family of systems (e.g., Windows Server), Linux, Mac™ OS X, IRIX 32, or IRIX 64. Other operating systems may be used.

Embodiments can include computer-readable storage medium containing computer-readable instructions or computer program code. For example, the computer-readable storage medium or computer-usable medium may be, but is not limited to, a random-access memory (RAM), read-only memory (ROM), or a persistent store, such as a mass storage device, hard drives, CDROM, DVDROM, tape, erasable programmable read-only memory (EPROM or flash memory), or any magnetic, electromagnetic, optical, or electrical means or system, apparatus or device for storing information.

Although certain embodiments have been described and illustrated with respect to certain example network topographies and node names and configurations, it should be understood that embodiments are not so limited, and any practical network topography is possible, and node names and configurations may be used. Aspects of the one or more embodiments described herein may be implemented on one or more computers executing software instructions, and the computers may be networked in a client-server arrangement or similar distributed computer network.

Embodiments may be applied to data, storage, industrial networks, and the like, in any scale of physical, virtual or hybrid physical/virtual network, such as a very large-scale wide area network (WAN), metropolitan area network (MAN), or cloud-based network system, however, those skilled in the art will appreciate that embodiments are not limited thereto, and may include smaller-scale networks, such as LANs (local area networks). Thus, aspects of the one or more embodiments described herein may be implemented on one or more computers executing software instructions, and the computers may be networked in a client-server arrangement or similar distributed computer network. The network may comprise any number of server and client computers and storage devices, along with virtual data centers (vCenters) including multiple virtual machines. The network provides connectivity to the various systems, components, and resources, and may be implemented using protocols such as Transmission Control Protocol (TCP) and/or Internet Protocol (IP), well known in the relevant arts. In a distributed network environment, the network may represent a cloud-based network environment in which applications, servers and data are maintained and provided through a centralized cloud-computing platform.

Although embodiments are described and illustrated with respect to certain example implementations, platforms, and applications, it should be noted that embodiments are not so limited, and any appropriate network supporting or executing any application may utilize aspects of the backup management process described herein. Furthermore, network environment 100 may be of any practical scale depending on the number of devices, components, interfaces, etc. as represented by the server/clients and other elements of the network. For example, network environment 100 may include various different resources such as WAN/LAN networks and cloud networks 102 are coupled to other resources through a central network 110.

For the sake of clarity, the processes and methods herein have been illustrated with a specific flow, but it should be understood that other sequences may be possible and that some may be performed in parallel, without departing from the spirit of the invention. Additionally, steps may be subdivided or combined. As disclosed herein, software written in accordance with the present invention may be stored in some form of computer-readable medium, such as memory or CD-ROM, or transmitted over a network, and executed by a processor.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

All references cited herein are intended to be incorporated by reference. While one or more implementations have been described by way of example and in terms of the specific embodiments, it is to be understood that one or more implementations are not limited to the disclosed embodiments. Therefore, the scope of the appended claims should be accorded the broadest interpretation so as to encompass all such modifications and similar arrangements.

1. A method of processing membership changes in a cluster system with shared services to minimize risk of data corruption, comprising:
collecting membership change events for queuing in a persistent queue;
first publishing the membership change events by delivery in order of arrival to other subscribing members of the cluster system, wherein each subscribing member executes a local callback function based on a received membership change event;
second publishing a fencing operation to fence off a failed service involved in a published membership change event, wherein the fencing operation is performed using membership information of the cluster system and comprises deactivating and reactivating access tokens belonging to the failed service; and
third publishing, upon completion of the fencing operation, the membership change event to any remaining subscribing members exclusive of the failed service to prevent access by the failed service to shared resources of the cluster system and allow the performance of failover actions, wherein each publishing step is performed by a cluster-event membership module (CEM) residing in a node of the cluster system, and further wherein the CEM comprises a customizable and portable lightweight module using a smart client library processing events impacting cluster membership from one or more event generators.

2. The method of claim 1 further comprising determining if the fencing operation is complete before the third publishing step.

3. The method of claim 2 further comprising re-attempting the fencing operation for a defined number of times if the fencing operation is not complete.

4. The method of claim 1 wherein the membership change events comprise a service failure due to at least one of: a system crash, partial unavailability, or network partition change.

5. The method of claim 1 wherein the cluster system comprises a Santorini network processing containerized data utilizing a Kubernetes-based framework, and wherein the cluster system comprises part of a Data Domain deduplication backup system performing data protection operations for nodes of the cluster system.

6. The method of claim 5 wherein the collecting step is performed by a container orchestration service (COS) within Kubernetes.

7. (canceled)

8. The method of claim 6 wherein the CEM maintains a member list of existing services indicating service up/down status, and fencing states for service member changes.

9. The method of claim 8 wherein active members are granted access to the shared resources, and further wherein services in a down status have revoked access a storage layer storing the shared resources.

10. The method of claim 9 wherein the storage layer comprises block storage, and wherein access is granted using a unique reservation key for persistent storage reservation for each block storage access service that establishes membership at the time the service is initializing, and further wherein upon a service down status as detected by the COS, the COS revokes the unique reservation key for the detected service and invalidates access to the block storage.

11. The method of claim 9 wherein the storage layer comprises a key-value store (KVS) and further wherein access is granted through an access list of valid clients, and yet further wherein upon a service down status the access list is updated to invalidate access to the KVS.

12. A system processing membership changes in a cluster network having shared services to minimize risk of data corruption, comprising:
a hardware-based container orchestration service (COS) component collecting membership change events;
a persistent queue queuing the collected membership change events;
a hardware-based cluster-event membership module (CEM) publishing the membership change events by delivery in order of arrival to other subscribing members of the cluster system, wherein each subscribing member executes a local callback function based on a received membership change event, wherein the CEM comprises a customizable and portable lightweight module using a smart client library processing events impacting cluster membership from one or more event generators; and
a fencing component performing a fencing operation to fence off a failed service involved in a published membership change event, wherein upon completion of the fencing operation, the membership change event is published by the CEM to any remaining subscribing members exclusive of the failed service to prevent access by the failed service to shared resources of the cluster system and allow the performance of failover actions, wherein the fencing operation is performed using membership information of the cluster system and comprises deactivating and reactivating access tokens belonging to the failed service.

13. The system of claim 12 wherein if the fencing operation is not complete within a defined amount of time, the fencing component re-attempts the fencing operation for a defined number of times until the fencing operation completes.

14. The system of claim 12 wherein the membership change events comprise a service failure due to at least one of: a system crash, partial unavailability, or network partition change.

15. The system of claim 12 wherein the cluster system comprises a Santorini network processing containerized data utilizing a Kubernetes-based framework, and wherein the cluster system comprises part of a Data Domain deduplication backup system performing data protection operations for nodes of the cluster system.

16. The system of claim 15 wherein the CEM maintains a member list of existing services indicating service up/down status, and fencing states for service member changes.

17. The system of claim 16 wherein active members are granted access to the shared resources, and further wherein services in a down status have revoked access a storage layer storing the shared resources.

18. The system of claim 17 wherein the storage layer comprises block storage, and wherein access is granted using a unique reservation key for persistent storage reservation for each block storage access service that establishes membership at the time the service is initializing, and further wherein upon a service down status as detected by the COS, the COS revokes the unique reservation key for the detected service and invalidates access to the block storage.

19. The system of claim 17 wherein the storage layer comprises a key-value store (KVS) and further wherein access is granted through an access list of valid clients, and yet further wherein upon a service down status the access list is updated to invalidate access to the KVS.

20. A method of processing membership changes in a cluster system with shared services to minimize risk of data corruption, comprising:
detecting a membership change event affecting a state change from up down of a service of the cluster system to create a down service;
fencing off the down service by invalidating access by the down service to a storage layer comprising at least one of block storage and a key value store (KVS), wherein the fencing operation is performed using membership information of the cluster system and comprises deactivating and reactivating access tokens belonging to the failed service; and
publishing, upon completion of the fencing step, the membership change event to any remaining subscribing services exclusive of the down service to prevent access by the down service to shared resources of the cluster system and allow the performance of failover actions. wherein the publishing is performed by a cluster-event membership module (CEM) residing in a node of the cluster system, and further wherein the CEM comprises a customizable and portable lightweight module using a smart client library processing events impacting cluster membership from one or more event generators.
